(19) United States
(12) Patent Application Publication
(10) Pub. No.: US 2017/0139112 A1
(43) Pub. Date: May 18, 2017

(54) Liquid Crystal Display Device And Backlight Module

(71) Applicant: Shenzhen China Star Optoelectronics Technology Co., Ltd., Shenzhen, Guangdong (CN)

(72) Inventor: Yong FAN, Shenzhen, Guangdong (CN)

(73) Assignee: Shenzhen China Star Optoelectronics Technology Co., Ltd., Shenzhen, Guangdong (CN)

(21) Appl. No.: 14/776,807

(22) PCT Filed: Aug. 14, 2015
(86) PCT No.: PCT/CN2015/086998

§ 371 Date: Sep. 15, 2015

(30) Foreign Application Priority Data
Jul. 3, 2015 (CN) 201510391714.4

(51) Int. Cl. F21V 8/00

(52) U.S. Cl. CPC G02B 6/0068

(57) ABSTRACT

The backlight module contains a light guide plate and two light source members. The light guide plate has a longer light incident face and a shorter light incident face, and the longer and shorter light incident faces are end-to-end connected at a corner of the light guide plate. A first light source member is positioned oppositely along the longer light incident face, and a second light source member is positioned oppositely along the shorter light incident face. The present invention also provides a liquid crystal display (LCD) device including the backlight module. The LCD device and the backlight module achieve enhanced light coupling efficiency without interfering the thickness reduction of the LCD device and the backlight module.

### BACKGROUND OF THE INVENTION

### 1. Field of the Invention

The present invention relates to liquid crystal display techniques, and in particular to a liquid crystal display device and a backlight module.

### 2. The Related Arts

As large-dimensional liquid crystal displays (LCD)s with 4K or even 8K resolution become the mainstream product, the number of pixels of the LCDs increases significantly. This leads to pixels with reduced size, aperture ratio, and penetration. As such, the brightness of the backlight modules have to be increased.

The conventional edge lit technique along a single longer edge of the light guide plate fails to achieve the required brightness increase, not only due to the reduced penetration but also due to the limitation from light emitting diode (LED) brightness and heat dissipation. Therefore, the existing solution is to use the edge lit technique along both the shorter or longer edges of the light guide plate. However, for a backlight module using this solution, its light guide plate is often warped as the light guide plate absorbs heat and moisture. To prevent the warped light guide plate from producing ununiformed illumination and from impacting/damaging the LEDs, the distances between the LEDs and the light guide plate is lengthened. However, the increased distance results in a significantly reduced light coupling efficiency.

Additionally, there is an increasing trend for thinned LCDs in recent days. But backlight modules using the edge lit technique along both the shorter or longer edges of the light guide plates are difficult to achieve a thinned design.

### SUMMARY OF THE INVENTION

To obviate the shortcoming of the prior art, the present invention provides a novel backlight module. The backlight module contains a light guide plate and two light source members. The light guide plate has a longer light incident face and a shorter light incident face, and the longer and shorter light incident faces are end-to-end connected at a corner of the light guide plate. A first light source member is positioned oppositely along the longer light incident face, and a second light source member is positioned oppositely along the shorter light incident face.

Specifically, the second light source member has an end adjacent to the corner of the light guide plate.

Specifically, the second light source member has a length no more than 60% of the shorter light incident face's length.

Specifically, each light source member contains a circuit board, and a number of point light sources configured at intervals on the circuit board opposing a corresponding light incident face.

Specifically, each light source member further contains at least a separation element configured on the circuit board between two neighboring point light sources, and each separation element has an end contacting the corresponding light incident face.

Specifically, each circuit board is a printed circuit board.

Specifically, each point light source is a light emitting diode (LED).

The present invention also provides a liquid crystal display (LCD) device that contains a backlight module as describe above and a liquid crystal panel opposing the backlight module. The backlight module provides uniform illumination to the liquid crystal panel.

The LCD device and the backlight module achieve enhanced light coupling efficiency without interfering the thickness reduction of the LCD device and the backlight module.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a top-view diagram showing a backlight module according to an embodiment of the present invention;

FIG. 2 is a schematic sectional diagram showing the backlight module along the A-A line of FIG. 1; and

FIG. 3 is a schematic side-view diagram showing a liquid crystal display (LCD) device according to an embodiment of the present invention.

### DETAILED DESCRIPTION OF THE PREFERRED EMBODIMENTS

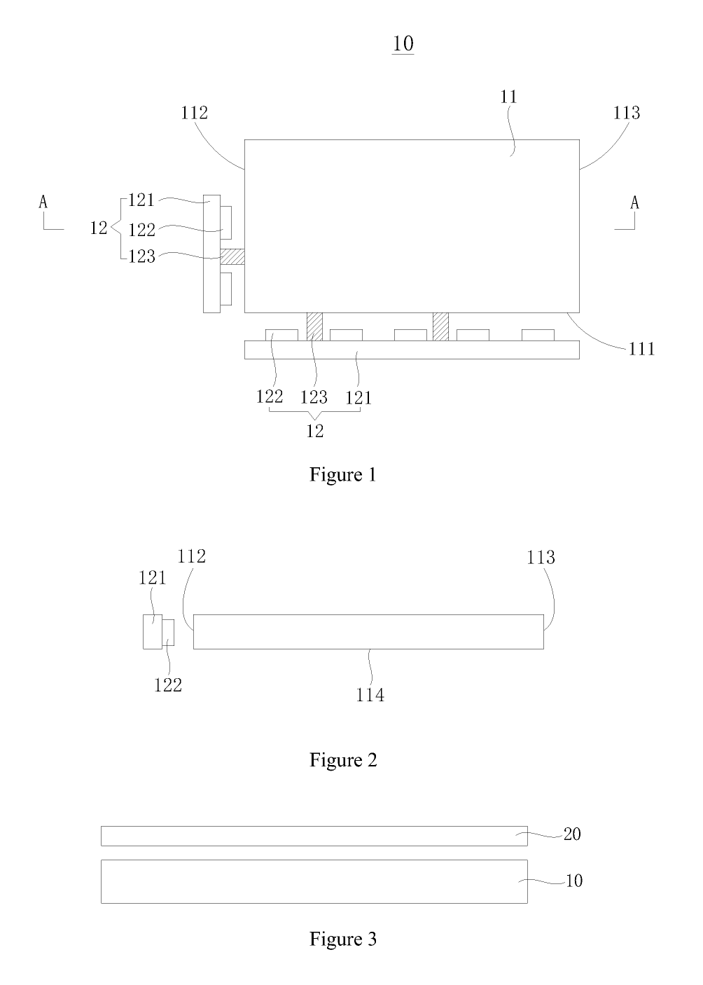

FIG. 1 is a top-view diagram showing a backlight module 10 for a liquid crystal display (LCD) device according to an embodiment of the present invention. FIG. 2 is a schematic sectional diagram showing the backlight module 10 along the A-A line of FIG. 1.

As shown in FIGS. 1 and 2, the backlight module 10 contains a light guide plate 11, and light source members 12. For people of the related art, it should be well known that the backlight module further contains other elements such as back plate, plastic frame, optical film, reflection plate, etc. As these elements are of little relevance to the present invention, their details are omitted here.

In the present embodiment, the light guide plate 11 has the shape of a cuboid. But in alternative embodiments, the light guide plate 11 can have another shape. The light guide plate 11 has a first light incident face 111, a second light incident face 112, and a third light incident face 113. The second light incident face 112 has an end connected to a first end of the first light incident face 111. The third light incident face 113 also has an end connected to a second end of the first light incident face 111 and opposes the second light incident face 112. In the present embodiment, the first incident face 111 is along a longer edge of the cuboid whereas the second and third incident faces 112 and 113 are along two shorter edge of the cuboid, respectively. However, alternative embodiments may have a different arrangement.

Two light source members 12 are positioned oppositely to the first and second light incident faces 111 and 112, respectively. Alternative embodiments may have a different arrangement. For example, a first light source member 12 and a second light source member 12 are positioned oppositely to the first and third light incident faces 111 and 113, respectively. In the present embodiment, each light source member 12 contains a circuit board 121, a number of point light sources 122 positioned at intervals on the circuit board 121 opposing the first or second light incident faces 111 and 112. In the present embodiment, the circuit board 121 is a printed circuit board (PCB) and each point light source 122 is a light emitting diode (LED). But the present invention is not limited to these embodiments.

An end of the second light source member 12 along the second light incident face 112 is adjacent to the first end of the first light incident face 111. In addition, the second light source member 12 has a length not exceeding 60% of the length of the second light incident face 112 so as not to adversely affect the thickness reduction of the LCD device.

In addition, to maintain a distance between the light source members 12 and the corresponding light incident faces 111, 112, at least a separation element 123 is configured on each circuit board 121 between two neighboring point light sources 122. Each separation element 123 has an end contacting a corresponding light incident face 111 or 112. For example, the first light source member 12 has separation elements 123 contacting the first light incident face 111, and the second light source member 12 has a separation element 123 contacting the second light incident face 112.

In order to achieve uniform backlight from the backlight module 10, the present embodiment can provide a number of dots (not shown) along a bottom face 114 of the light guide plate 11. The dots are distributed more densely (i.e., have a higher density) where they are positioned closer to the corresponding light source member 12, and more sparsely (i.e., have a lower density) where they are positioned more distant from the corresponding light source member 12.

FIG. 3 is a schematic side-view diagram showing a LCD device according to an embodiment of the present invention.

As illustrated, the LCD device contains a backlight module 10 as describe above and as shown in FIGS. 1 and 2, and a liquid crystal panel 20 opposing the backlight module 10. The backlight module 10 provides uniform illumination to the liquid crystal panel 20 so as to illuminate images of the liquid crystal panel 20.

As described above, the LCD device and the backlight module of the present invention achieve enhanced light coupling efficiency without interfering the thickness reduction of the LCD device and the backlight module.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A backlight module, comprising:
a light guide plate having a longer light incident face and a shorter light incident face, the longer and shorter light incident faces end-to-end connected at a corner of the light guide plate;
a first light source member positioned oppositely along the longer light incident face; and
a second light source member positioned oppositely along the shorter light incident face;
wherein the second light source member has an end adjacent to the corner of the light guide plate; and the second light source member has a length no more than 60% of the shorter light incident face's length.

2. The backlight module as claimed in claim 1, wherein each light source member comprises a circuit board, and a plurality of point light sources configured at intervals on the circuit board opposing a corresponding light incident face.

3. The backlight module as claimed in claim 2, wherein each light source member further comprises at least a separation element configured on the circuit board between two neighboring point light sources; and each separation element has an end contacting the corresponding light incident face.

4. The backlight module as claimed in claim 2, wherein each circuit board is a printed circuit board.

5. The backlight module as claimed in claim 2, wherein each point light source is a light emitting diode (LED).

6. A backlight module, comprising:
a light guide plate having a longer light incident face and a shorter light incident face, the longer and shorter light incident faces end-to-end connected at a corner of the light guide plate;
a first light source member positioned oppositely along the longer light incident face; and
a second light source member positioned oppositely along the shorter light incident face.

7. The backlight module as claimed in claim 6, wherein the second light source member has an end adjacent to the corner of the light guide plate.

8. The backlight module as claimed in claim 7, wherein the second light source member has a length no more than 60% of the shorter light incident face's length.

9. The backlight module as claimed in claim 6, wherein each light source member comprises a circuit board, and a plurality of point light sources configured at intervals on the circuit board opposing a corresponding light incident face.

10. The backlight module as claimed in claim 9, wherein each light source member further comprises at least a separation element configured on the circuit board between two neighboring point light sources; and each separation element has an end contacting the corresponding light incident face.

11. The backlight module as claimed in claim 9, wherein each circuit board is a printed circuit board.

12. The backlight module as claimed in claim 9, wherein each point light source is a LED.

13. A liquid crystal display (LCD) device, comprising a liquid crystal panel and a backlight module opposing and providing uniform illumination to the liquid crystal panel, wherein the backlight module comprises:
a light guide plate having a longer light incident face and a shorter light incident face, the longer and shorter light incident faces end-to-end connected at a corner of the light guide plate;
a first light source member positioned oppositely along the longer light incident face; and
a second light source member positioned oppositely along the shorter light incident face.

14. The LCD device as claimed in claim 13, wherein the second light source member has an end adjacent to the corner of the light guide plate.

15. The LCD device as claimed in claim 14, wherein the second light source member has a length no more than 60% of the shorter light incident face's length.

16. The LCD device as claimed in claim 13, wherein each light source member comprises a circuit board, and a plurality of point light sources configured at intervals on the circuit board opposing a corresponding light incident face.

17. The LCD device as claimed in claim 16, wherein each light source member further comprises at least a separation element configured on the circuit board between two neighboring point light sources; and each separation element has an end contacting the corresponding light incident face.

18. The LCD device as claimed in claim 16, wherein each circuit board is a printed circuit board.

19. The LCD device as claimed in claim 16, wherein each point light source is a LED.
